(19) United States
(12) Patent Application Publication
(10) Pub. No.: US 2013/0007373 A1
(43) Pub. Date: Jan. 3, 2013

(54) REGION BASED CACHE REPLACEMENT POLICY UTILIZING USAGE INFORMATION

(75) Inventors: Bradford M. Beckmann, Redmond, WA (US); Arkaprava Basu, Madison, WI (US); Steven K. Reinhardt, Vancouver, WA (US)

(73) Assignee: ADVANCED MICRO DEVICES, INC., Sunnyvale, CA (US)

(21) Appl. No.: 13/173,441

(22) Filed: Jun. 30, 2011

(51) Int. Cl. G06F 12/12

(52) U.S. Cl. 711/136; 711/E12.07

(57) ABSTRACT

A method, apparatus, and system for replacing at least one cache region selected from a plurality of cache regions, wherein each of the regions is composed of a plurality of blocks is disclosed. The method includes applying a first algorithm to the plurality of cache regions to limit the number of potential candidate regions to a preset value, wherein the first algorithm assesses the ability of a region to be replaced based on properties of the plurality of blocks associated with that region; and designating at least one of the limited potential candidate regions as a victim based region level information associated with each of the limited potential candidate regions.

### FIELD OF INVENTION

This application is related to cache replacement policy, and specifically to region based cache replacement policy utilizing usage information.

### BACKGROUND

Cache algorithms, sometimes referred to as replacement algorithms or replacement policies, are optimizing structures or algorithms that a computer program or hardware structure may follow to manage a cache of information stored on a computer. When the cache is full, a decision must be made as to which items to discard to make room for new ones. This decision is governed by one or more cache algorithms.

Metrics may be used to determine the efficacy of a cache algorithm. For example, the hit rate of a cache describes how often a searched for item is actually found in the cache. More efficient cache algorithms generally keep track of more usage information in order to improve the hit rate. The latency of the cache describes how long after requesting a desired item the cache returns the item. Generally, cache algorithms compromise between hit rate and latency.

One cache algorithm that is frequently used is referred to as the leastrecently-used (LRU) algorithm. This algorithm tracks what was used when and discards the least recently used item. General implementations of LRU track age bits for cache lines and track the least recently used cache line based on these age bits. In such implementations, every time a cache line is used, the age of all other cache lines changes.

Another cache algorithm is the most recently used (MRU) algorithm. This algorithm discards the most recently used item first using the logic that a recently used item will not likely be needed in the near future. MRU algorithms are most useful in situations where an older item is more likely to be accessed.

Pseudo-least-recently-used (pseudoLRU, also known as treeLRU) is a cache algorithm that is efficient in replacing an item that most likely has not been accessed very recently. PseudoLRU operates with a set of items and a sequence of access events to the items. This algorithm works using a binary search tree for the items, for example. Each node of the tree has a one-bit flag denoting the direction to go to find the desired element. One setting of the bit flag is go left to find the element and the other is go right to find the element. To replace an element, the tree may be traversed according to the values of the flags. To update the tree with access to an item, the tree is traversed to find the item and, during the traversal, the flag is set to denote the direction that is opposite to the direction taken.

Other cache algorithms are also known in the field. These include: Random Replacement, which randomly selects a candidate item and discards candidate to make space when necessary; Segmented LRU, which divides the cache a probationary segment and a protected segment to decide data to be discarded; and Least Frequently Used, which counts how often an item is needed and discards those that are used least often.

All of these conventional cache algorithms maintain coherence at the granularity of cache blocks. However, as cache sizes have become larger, the efficacy of these cache algorithms has decreased. Inefficiencies have been created both by storing accessing, and controlling information and data at the block level.

Solutions for this decreased efficacy have included attempts to provide macro-level cache policies by exploiting coherence information of larger regions. These larger regions may include a contiguous set of cache blocks in physical address space, for example. While such solutions have been lacking in maintaining granularity of data transfer at the cache block level with block level algorithms while exploiting region level information, these solutions have allowed for the storage of control information at the region level.

By moving to a region-based cache structure, the cost associated with incorrectly discarded information grows. The penalty for the cache algorithm selecting the wrong region increases. For example, when performing cache replacements on the block level, replacing the wrong block, or one that is needed in the near future, only costs the bandwidth, time and effort to reconstitute that one block back into the cache. When this is applied to the region level, the cost associated with replacement may grow with the number of blocks in a region as the multiplier. For example, in a four block per region situation the cost of incorrect replacement of a region may grow four times. When performing cache replacements on the region level, replacing the wrong region, or one that is needed in the near future, costs the bandwidth, time and effort to reconstitute that region back into the cache. When the number of blocks in a region grows to four blocks, sixteen blocks, 256 blocks, 1024 blocks, and beyond, the time, bandwidth and effort to replace those 4, 16, 256, 1024 or more blocks may become quite large.

### SUMMARY OF EMBODIMENTS

A method, apparatus and system of replacing cache regions are disclosed. The method includes identifying at least one of a plurality of potential replacement cache regions with the minimum usage density, wherein one of said identified at least one of said plurality replacement cache regions is designated for replacement.

The method may further include determining the usage density of said plurality of potential replacement cache regions, selecting a plurality of potential replacement cache regions using a first replacement algorithm, iteratively applying said first replacement algorithm until the number of cache regions included in said plurality of potential replacement cache regions is equal to a preset value, selecting one of said identified at least one of a plurality of potential replacement cache regions using a second replacement algorithm, and/or replacing said region designated for replacement.

The system providing cache management controlled by a central processor, wherein the cache management operates to select a replacement region selected from a plurality of cache regions, wherein each of said cache regions comprises a plurality of blocks includes a processor applying a first algorithm to the plurality of cache regions to limit the number of potential candidate regions to a preset value, wherein said first algorithm assesses the ability of a region to be replaced based on properties of the plurality of blocks associated with that region, and designating at least one of said limited potential candidate regions as a victim based region level information associated with each of said limited potential candidate regions.

A method, apparatus, and system for replacing at least one cache region selected from a plurality of cache regions, wherein each of said regions comprises a plurality of blocks is disclosed. The method includes applying a first algorithm to the plurality of cache regions to limit the number of potential candidate regions to a preset value, wherein said first algorithm assesses the ability of a region to be replaced based on properties of the plurality of blocks associated with that region; and designating at least one of said limited potential candidate regions as a victim based region level information associated with each of said limited potential candidate regions. The method, apparatus, and system may also include selecting one of said limited potential candidate regions using a second algorithm.

### BRIEF DESCRIPTION OF THE DRAWINGS

FIG. 1 illustrates a computer system including the interface of the central processing unit, main memory, and cache;

FIG. 2 illustrates the lost opportunity with region level data structures using only LRU information to select a victim for replacement;

FIG. 3 illustrates region level data structures with a replacement policy using region level data and usage information;

FIG. 4 is an example region based cache replacement method utilizing usage information; and

FIG. 5 is an example of a modified pdeudoLRU tree for managing set-associative grain structures.

### DETAILED DESCRIPTION OF THE EMBODIMENTS

A cache algorithm that operates on the block level while exploiting region level information is provided. This macro-level cache policy may provide the capability to maintain cache data structures accessible at region granularity to quickly lookup region level information. These structures may include conventional set-associative structures but each entry in the structure may operate at the region level instead of a block, for example. These region entries may contain information about cache blocks that are present within the given region and use dual-grain protocols. This macro-level policy may manage region grain structures using conventional replacement policies such as LRU or pseudo-LRU, for example.

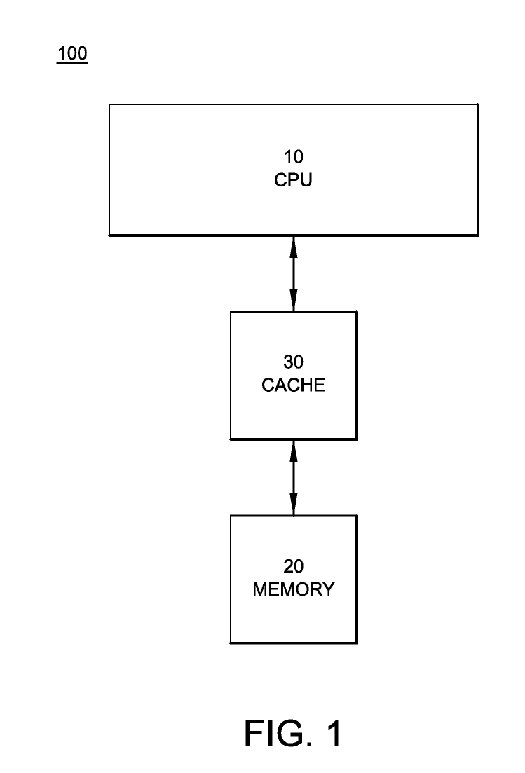

FIG. 1 shows a computer system 100 including the interface of the central processing unit (CPU) 10, main memory 20, and cache 30. CPU 10 may be the portion of computer system 100 that carries out the instructions of a computer program, and may be the primary element carrying out the functions of the computer. CPU 10 may carry out each instruction of the program in sequence, to perform the basic arithmetical, logical, and input/output operations of the system.

Suitable processors for CPU 10 include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

Typically, CPU 10 receives instructions and data from a read-only memory (ROM), a random access memory (RAM), and/or a storage device. Storage devices suitable for embodying computer program instructions and data include all forms of non-volatile memory, including by way of example, semiconductor memory devices, magnetic media such as internal hard disks and removable disks, magneto-optical media, and optical media such as CD-ROM disks and DVDs. Examples of computer-readable storage mediums also may include a register and cache memory. In addition, the functions within the illustrative embodiments may alternatively be embodied in part or in whole using hardware components such as ASICs, FPGAs, or other hardware, or in some combination of hardware components and software components.

Main memory 20, also referred to as primary storage, internal memory, and memory, may be the memory directly accessible by CPU 10. CPU 10 may continuously read instructions stored in memory 20 and may execute these instructions as required. Any data may be stored in memory 20 generally in a uniform manner. Main memory 20 may comprise a variety of devices that store the instructions and data required for operation of computer system 100. Main memory 20 may be the central resource of CPU 10 and may dynamically allocate users, programs, and processes. Main memory 20 may store data and programs that are to be executed by CPU 10 and may be directly accessible to CPU 10. These programs and data may be transferred to CPU 10 for execution, and therefore the execution time and efficiency of the computer system 100 is dependent upon both the transfer time and speed of access of the programs and data in main memory 20.

In order to increase the transfer time and speed of access beyond that achievable using memory 20 alone, computer system 100 may use a cache 30. Cache 30 may provide programs and data to CPU 10 without the need to access memory 20. Cache 30 may take advantage of the fact that programs and data are generally referenced in localized patterns. Because of these localized patterns, cache 30 may be used as a type of memory that may hold the active blocks of code or data. Cache 30 may be viewed for simplicity as a buffer memory for main memory 20. Cache 30 may not interface directly with main memory 20, although cache 30 may use information stored in main memory 20. Indirect interactions between cache 30 and main memory 20 may be under the direction of CPU 10.

While cache 30 is available for storage, cache 30 may be more limited than memory 20, most notably by being a smaller size. As such, cache algorithms may be needed to determine which information and data is stored within cache 30. Cache algorithms may run on or under the guidance of CPU 10. When cache 30 is full, a decision may be made as to which items to discard to make room for new ones. This decision is governed by one or more cache algorithms.

Cache algorithms may be followed to manage information stored on cache 30. When cache 30 is full, the algorithm may choose which items to discard to make room for the new ones. In the past, as set forth above, cache algorithms often operated on the block level so that decisions to discard information occurred on a block by block basis and the underlying algorithms developed in order to effectively manipulate blocks in this way. As cache sizes have increased and the speed for access is greater than ever before, cache decisions may be examined by combining blocks into regions and acting on the region level instead. The use of block level algorithms on region-based structures results in deficiencies that may be rectified as shown herein.

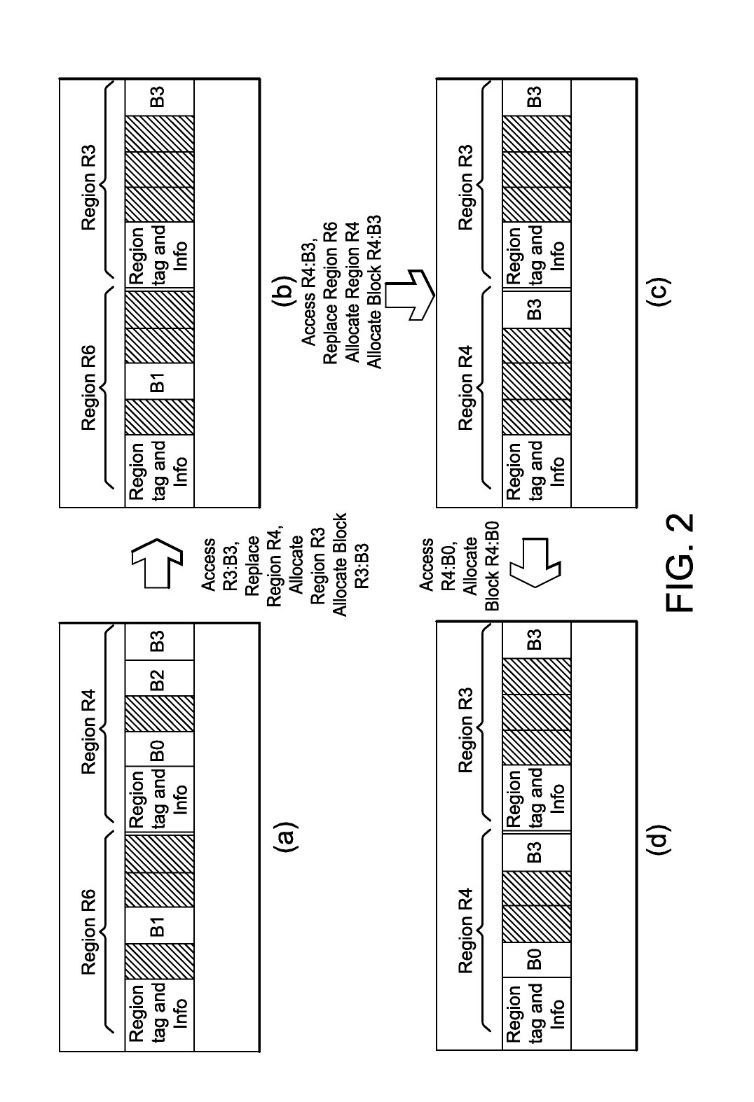

FIG. 2 is an illustration of the lost opportunity with region level data structures using only LRU information to select a victim for replacement. FIG. 2 provides an example of how only a recent access-based replacement policy results in lost opportunity in region grain set-associative structures.

For the example shown in FIG. 2, each region is capable of holding four consecutive cache blocks in the physical address space. FIG. 2(a)-(d) (clockwise) shows different contents of a particular row in a set-associative region grain structure. Between each of the two states of the structure, there is an annotation of the event that caused the transition, along with the actions that resulted in the new state of content. As an initial starting condition, region R6 is the MRU entry.

FIG. 2(a) shows the initial starting condition as region R6 with block B1 and region R4 with blocks B0, B2 and B3. The transition between FIG. 2(a) and FIG. 2(b) occurs with the event to access block R3:B3. Accessing block B3 in region R3 necessitates eviction of one of the two region entries in the set, which using a replacement policy based only on access history victimizes region entry for R4 as region R6 is the MRU entry. Region R4, shown in FIG. 2(a), is replaced with region R3, shown in FIG. 2(b) as having replaced region R4, while region R6 remains in Figure 2(b) as it was in FIG. 2(a). However, the value of maintaining region R4 may have been greater considering that region R4 holds more cache blocks in its region and, since operation is on a regional level, all of these blocks need to be evicted when region R4 is victimized. Accordingly, the value of region R4 may be more than that of region R6 given that replacement of region R4 may cause up to three extra misses in the future compared to only one possible miss if region R6 was victimized. More specifically, evicting region R6 may cause a miss only with respect to block B1, while evicting region R4 may cause misses with respect to blocks B0, B2 and B3. After this access of block R3:B3 occurs, region R4 is replaced with region R3 including allocated block R3: B3, as may be seen in FIG. 2(b).

As shown, access to block R4:B3 causes the transition from FIG. 2(b) to FIG. 2(c). Because region R4 had been victimized as a result of the previous event, only regions R6 and R3 are accessible and access to R4:B3 requires a victim as determined by the replacement policy. In this case region R6 is replaced to allocate region R4 to provide access to block R4:B3, as shown in FIG. 2(c) because R3 is now the MRU entry.

Subsequent access to block R4:B0 causes the transition from FIG. 2(c) to FIG. 2(d). As a result of the fact that region R4 is already allocated there is no need to find a victim via the replacement policy. Block R4:B0 may be accessed as shown in FIG. 2(d).

Based on the initial victimization of region R4, the technique described above may victimize a region that causes additional potential misses in the future because of a misplaced reliance on the most recently used block and may not provide the optimal region based cache replacement policy. This may be attributable to grouping of blocks into regions and not accounting for region based information.

There is also a cost associated with selecting region R4 for replacement. This cost underlies the fact that region R4 had three blocks populated in the initial starting point. Once region R4 is replaced, all three of these blocks (B0, B2, B3) are no longer accessible from the cache. In order to access the information contained in any of the three blocks of region R4, this information may need to be accessed from memory and placed into cache using a cache algorithm, thereby replacing other information in the cache. The discarding of region R4 causes the underlying replacement cost to be that of replacing the three blocks that were in use in region R4. This is compared to the replacement cost associated initially with region R6 and the one populated block B1.

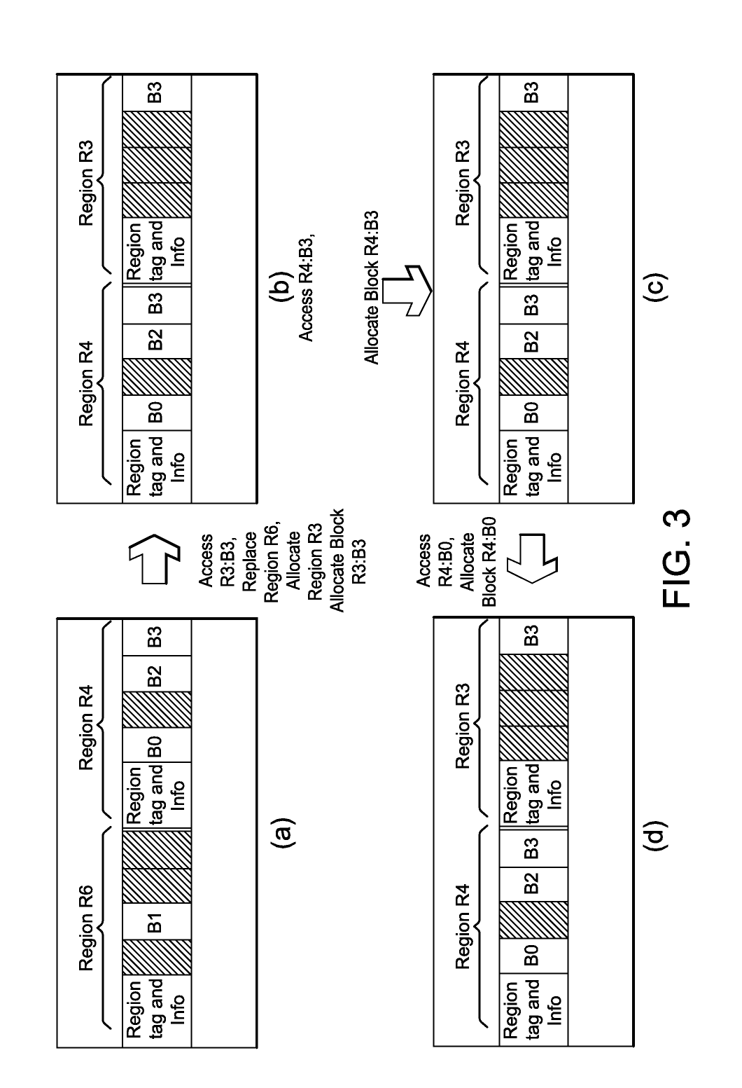

FIG. 3 illustrates operation of a replacement policy using region level data structures and usage information. This replacement policy using region level data structures and usage information eliminates the lost opportunity described and set forth in FIG. 2. Similar to FIG. 2, FIG. 3 shows two-way set associative structure containing region entries with each region capable of holding four consecutive cache blocks in the physical address space. FIG. 3(a)-(d) (clockwise), shows different contents of a particular row in a set associate region grain structure. Between each of the two states of the structure, there is an annotation of the event that caused the transition, along with actions that resulted in the new state of content. As in initial starting condition, region R6 is the MRU entry.

FIG. 3(a), identical to FIG. 2(a), shows the initial starting condition with region R6 with block B1 and region R4 with blocks B0, B2 and B3. The transition between FIG. 3(a) and FIG. 3(b) occurs as the event to access block R3:B3 occurs. This access of block B3 in region R3 necessitates eviction of one of the two region entries in the set, causing a replacement policy to be followed. Unlike the replacement policy demonstrated in the FIG. 2 based only on access history to victimize region R4, this replacement policy of FIG. 3 utilizes usage information within the regions under consideration for victimization in order to determine the appropriate replacement candidate. In this way, the value of region R4 may be determined to be higher than that of region R6 because region R4 holds more cache blocks in its region, all of which will need to be evicted if that region is replaced. Region R4 has 3 cache blocks—B0, B2 and B3—while region R6 only has a single cache block—B1. Based on usage information employed in the present region-based cache replacement policy, it may be determined that it is three times more likely that region R4 will be needed in the future than region R6 and/or the replacement costs of region R4 is greater than the replacement costs of region R6. Therefore, based on a usage density-based and/or replacement costs policy R6 may be chosen as the victim for replacement. After this access and replacement, as may be seen in FIG. 3(b), region R4 with blocks B0, B2 and B3 and region R3 with block B3 exist.

As shown, access to block R4:B3 causes a transition from FIG. 3(b) to FIG. 3(c). Because region 4 had not been victimized as a result of the previous event, as had been the case in the example of FIG. 2, access to R4:B3 does not require use of the replacement policy. In this case, R4:B3 may be accessed, as shown in FIG. 3(c).

Subsequent access to block R4:B0 causes the transition from FIG. 3(c) to FIG. 3(d). As a result of the fact that region R4 is already allocated there is no need to find a victim via a replacement policy. Block R4:B0 may be accessed as shown in FIG. 3(d).

It should be noted that while the present examples use two regions of four blocks each, any number of regions, each containing any number of blocks may be used. Further, each region does not necessarily need to contain the same number of blocks as other regions. In addition, regions of blocks are discussed, but the present disclosure also includes using regions of regions of blocks as well.

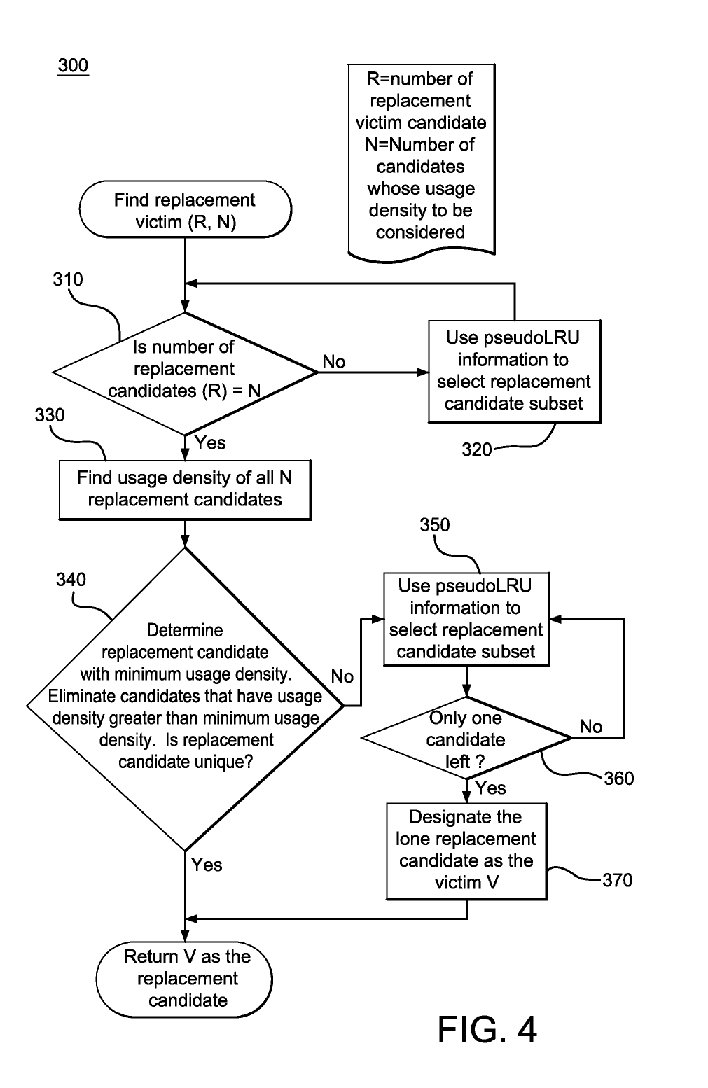

FIG. 4 is an example region-based cache replacement method 300 utilizing usage information. Method 300 seeks to determine an optimal cache replacement victim based on a number of cache replacement victim candidates, denoted as R, and a number of cache replacement candidates with usage density to be considered, denoted as N. Initially R may be set to include all regions within a given set. That is, at the beginning, all regions may be considered victim candidates. N may be set by software, BIOS, or hardwired, for example. In step 310, a comparison of R and N is performed. If R≠N, then step 320 may be performed. In step 320, method 300 uses pseudo least-recently-used (pseudoLRU) information to select a replacement candidate subset. This selected replacement candidate subset may be reanalyzed in step 310 by re-comparing R and N. This loop may be continued until the comparison of step 310 determines that R=N. This may provide a higher level of control to allow N to be preset so the usage information is not calculated for all regions in the cache, for example.

When the comparison of step 310 determines that R equals N, then the usage density of all N replacement candidates may be determined at step 330. As set forth herein, usage density of a region may be defined by how many cache blocks of the region are valid. A comparison of the usage density of all R replacement candidates may be performed at step 340.

Step 340 compares the usage density of all R replacement candidates, determines the minimum usage density found in the set of potential replacement candidates, and eliminates replacement candidates that that do not have the minimum usage density. If only a single candidate has the minimum usage density as determined at step 340, that candidate may be returned as the replacement candidate.

If more than one replacement candidate shares the minimum usage density as determined in step 340, pseudoLRU information may be used to select the victim at step 350. Since the usage density of all replacement candidates in this new subset are equal and share the minimum usage density, as determined in step 340, pseudoLRU information may be used in step 350 in a loop along with step 360 to designate the victim of this subset at step 370. This victim may be returned as a replacement candidate. At step 350, a loop may be formed by continually using pseudoLRU information to narrow the candidate subset until only one candidate remains at step 360. Once there is a single lone replacement candidate remaining in the subset, that candidate may be designated as the victim V at step 370. This victim may be returned as a replacement candidate.

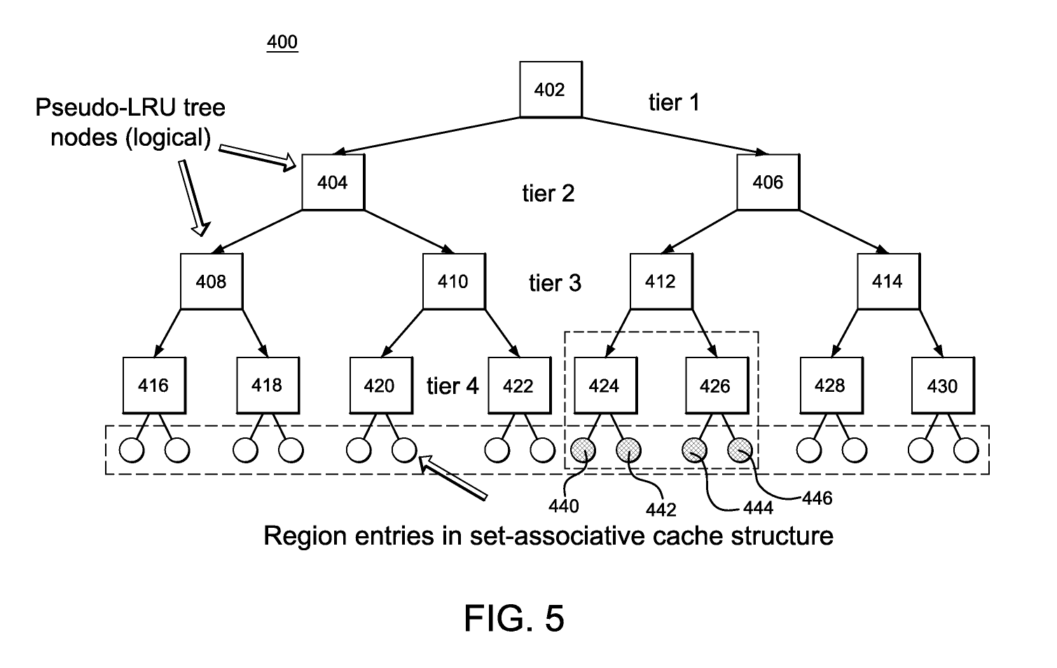

FIG. 5 is an example of a modified pdeudoLRU tree 400 for managing set-associative grain structures. As discussed, pseudo-least-recently-used (pseudoLRU) is a cache algorithm that is efficient in replacing an item that most likely has not been accessed very recently. PseudoLRU operates with a set of items and a sequence of access events to the items. PseudoLRU operates using a binary search tree for the items, for example. Each node of the tree has a one-bit flag denoting the direction to go to find the desired element. One setting of the bit flag is go left to find the element and the other is go right to find the element. To replace an element, the tree may be traversed according to the values of the flags. To update the tree with access to an item, the tree is traversed to find the item and, during the traversal, the flag is set to denote the direction that is opposite to the direction taken.

Tree 400, by way of example, operates to implement method 300 with each block 402, 404, . . . , 428 representing a flag bit in the pseudoLRU tree. A first tier of tree 400 includes, for example, block 402, the highest level flag bit in tree 400. A second tier of tree 400 includes blocks 404 and 406, for example, representing another level of flag bits. A third tier of tree 400 includes flag bit representations denoted as blocks 408, 410, 412, 414, for example. A fourth tier of tree 400 includes blocks 416, 418, . . . , 430. Below tier 4 in the representation of tree 400 in FIG. 5 are the associated region cache structures with each circle representing a region entry. Associated with each block, such as block 416, for example, is a set of two regions (the number of regions used in the examples throughout) that may be identified to be replaced. In order to arrive at replacing one of these regions, tree 400 may be traversed while following the flag bits 402, 404, 408, and 416, for example. In such a progression, flag bits 402, 404, and 408 may be set as to go left to find the desired element.

Starting at the top of tree 400 at region 402, method 300 may be employed to determine if R=N. In this analysis it is given that the number of candidates whose usage density will be considered is 4−N=4. Such a value may be present to balance the amount of block level information that needs to be analyzed. As shown in FIG. 5, there are 16 regions under block 402. These 16 regions set R≠N since R=16 and N=4, therefore flag bit 402 is read and acted upon by traversing tree 400 to a lower tier, progressing from tier 1 to tier 2 in this step, at bit level 406, for example. This traversal occurred to the right in tree 400 as a result of the identity of flag bit 402.

Analyzing from tier 2, there are 8 regions under block 406. These 8 regions set R≠N since R=8 and N=4, therefore flag bit 406 is read and acted upon by traversing tree 400 to a lower tier, progressing from tier 2 to tier 3 in this step, at bit level 412, for example. This traversal occurred to the left in tree 400 as a result of the identity of flag bit 406.

Moving the analysis to tier 3, there are 4 regions under block 412. These 4 regions set R=N since R=4 and N=4. Therefore, traversal of tree 400 may stop with respect to the pseudoLRU and the usage density of the identified N replacement candidates may be determined instead of a continued pseudoLRU progression to tier 4. The victim region may be determined based on which of the candidates, region 440, 442, 444, 446, has the lowest number of cache blocks populated in the region as described with respect to method 300.

In the situation where multiple ones of region 440, 442, 444, 446, such as region 440 and region 444, for example, each have the lowest number of cache blocks populated, all regions having more cache blocks populated may be eliminated as the possible replacement victim, such as region 442 and region 446, for example. A traditional algorithm may be used to determine which of the remaining potential replacement victims should be designated for replacement. One such cache algorithm that may be used is LRU or pseudoLRU, for example.

The present invention may be implemented in a computer program tangibly embodied in a computer-readable storage medium containing a set of instructions for execution by a processor or a general purpose computer. Method steps may be performed by a processor executing a program of instructions by operating on input data and generating output data.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general purpose computer or a processor.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

While specific embodiments of the present invention have been shown and described, many modifications and variations could be made by one skilled in the art without departing from the scope of the invention. The above description serves to illustrate and not limit the particular invention in any way.

What is claimed is:

1. A method, said method comprising:
identifying at least one of a plurality of potential replacement cache regions having a minimum number of valid cache blocks in the region; and
designating one of said identified at least one of said plurality replacement cache regions for replacement.

2. The method of claim 1, further comprising determining a number of valid cache blocks of each of said plurality of potential replacement cache regions.

3. The method of claim 1, further comprising selecting a plurality of potential replacement cache regions using a first replacement algorithm.

4. The method of claim 3, further comprising iteratively applying said first replacement algorithm until the number of cache regions included in said plurality of potential replacement cache regions is equal to a preset value.

5. The method of claim 3, wherein said first replacement algorithm comprises pseudoLRU.

6. The method of claim 1, further comprising selecting one of said identified at least one of a plurality of potential replacement cache regions using a second replacement algorithm.

7. The method of claim 6, wherein said second replacement algorithm comprises pseudoLRU.

8. The method of claim 1, further comprising replacing said region designated for replacement.

9. The method of claim 1, wherein said minimum number of valid cache blocks in the region comprises minimum usage density.

10. A computer system providing cache management, wherein the cache management operates to select a replacement region selected from a plurality of cache regions, wherein each of said cache regions is composed of a plurality of blocks, said system comprising:
a processor applying a first algorithm to the plurality of cache regions to limit the number of potential candidate regions to a preset value, wherein said processor applies said first algorithm to assess the ability of a region to be replaced based on properties of the plurality of blocks associated with that region, and designating at least one of said limited potential candidate regions as a victim for replacement based region level information associated with each of said limited potential candidate regions.

11. The system of claim 10, wherein said first algorithm comprises pseudoLRU.

12. The system of claim 10, wherein the region level information comprises a number of valid cache blocks in the region.

13. The system of claim 12, wherein said usage density comprises a ratio of the number of in-use blocks within the region compared to the total number blocks in the region.

14. The system of claim 10, wherein said processor further replaces said victim.

15. A method of replacing at least one cache region selected from a plurality of cache regions, wherein each of said regions is composed of a plurality of blocks, said method comprising:
applying a first algorithm to the plurality of cache regions to limit the number of potential candidate regions to a preset value, wherein said first algorithm assesses the ability of a region to be replaced based on properties of the plurality of blocks associated with that region; and
designating at least one of said limited potential candidate regions as a victim based region level information associated with each of said limited potential candidate regions.

16. The method of claim 15, wherein said first algorithm comprises pseudoLRU.

17. The method of claim 15, wherein the region level information comprises usage density.

18. The method of claim 17, wherein said usage density comprises a ratio of the number of in use blocks within the region compared to the total number blocks in the region.

19. The method of claim 15, further comprising selecting one of said limited potential candidate regions using a second algorithm.

20. The method of claim 19, wherein said second algorithm comprises pseudoLRU.
